(19) United States
(12) Patent Application Publication
(10) Pub. No.: US 2012/0086541 A1
(43) Pub. Date: Apr. 12, 2012

(54) SOLID-CORE SURGE ARRESTER

(75) Inventor: Jeffrey J. Kester, Bemus Point, NY (US)

(73) Assignee: COOPER TECHNOLOGIES COMPANY, Houston, TX (US)

(21) Appl. No.: 13/267,500

(22) Filed: Oct. 6, 2011

Related U.S. Application Data
(60) Provisional application No. 61/391,357, filed on Oct. 8, 2010.

(51) Int. Cl. H01C 7/10; H01C 17/06

(52) U.S. Cl. 338/21; 29/620

(57) ABSTRACT

A solid-core surge arrester includes a module assembly. The module assembly includes at least one metal oxide varistor (MOV) disk with an outer circumferential surface, and a material applied to the outer circumferential surface. The material includes multiple layers to allow the module assembly to withstand a bending moment under an approximately continuously applied load, and the material is configured to allow venting of gas that forms in the module assembly in a preferential direction.

### CROSS-REFERENCE TO RELATED APPLICATION

This application claims the benefit of U.S. Provisional Application No. 61/391,357, filed Oct. 8, 2010 and titled SOLID-CORE SURGE ARRESTER. The disclosure of this prior filed provisional application is incorporated by reference in its entirety.

### TECHNICAL FIELD

This description relates to a solid-core surge arrester.

### BACKGROUND

Electrical transmission and distribution equipment is subject to voltages within a fairly narrow range under normal operating conditions. However, system disturbances, such as lightning strikes and switching surges and faults resulting over voltages, may produce momentary or extended voltage levels that greatly exceed the levels experienced by the equipment during normal operating conditions. These voltage variations often are referred to as over-voltage conditions.

If not protected from over-voltage conditions, critical and expensive equipment, such as transformers, switching devices, computer equipment, and electrical machinery, may be damaged or destroyed by over-voltage conditions and associated current surges. Surge arresters may be used to protect system components from dangerous over-voltage conditions.

### SUMMARY

A solid-core arrester suitable for use in distribution class and station class surge arrester applications is described. As discussed below, a material layer provides axial strength to a solid-core arrester while also facilitating the venting of gases and/or plasmas that may be created upon arrester failure or malfunction. As a result, the solid-core arresters discussed below may be used in high-voltage applications and/or applications that require the arrester to withstand significant mechanical forces. Additionally, the material layer may be configured such that under failure mode conditions the solid-core arrester permits venting of gases and/or plasmas in a desired direction. The desired direction may be considered a preferential direction.

Some prior systems employ hollow-core arresters for high-voltage and/or high-strength applications. Hollow-core arresters include a housing (such as a reinforced plastic tube) that contains the components of the arrester and provides cantilever strength to the arrester. In a hollow-core arrester, the internal components of the arrester (such as a stack of metal oxide varistors or MOVs) are held away from the wall of the housing such that there is an air space between the internal components and the housing wall. The presence of the air space may allow humid air into the arrester, resulting in moisture ingress to the MOV disks and other internal components, increasing the probability of degraded performance and arrester failure.

In contrast, many solid-core arresters do not employ a housing that is separate from the internal components of the arrester. Instead, the internal components of a solid-core arrester may be held, at least in part, by a composite that is bonded to an outer circumferential surface of the MOV disks to create a substantially air-free interface between the outer circumferential surface of the MOV disks and the composite and between a weatherized housing of the arrester and the composite. As compared to hollow-core arresters, solid-core arresters may be easier to produce and more reliable due to the absence of the air space and the separate housing. However, because there is no separate housing, conventional solid-core arresters typically have lower cantilever strength than hollow-core arresters. In a conventional solid-core arrester, application of a high cantilever load may cause the component stack to lift on the tensile side, in turn causing edge to edge contact on the compression side. As these compressive loads approach point contact, mechanical fracture of the components and/or material layer may occur, which may lead to failure. Also, the quality of electrical contact among the various internal components may be reduced through the lifting effect, and internal partial discharges or poor current distribution during fault conditions may occur. Both of these conditions may lead to permanent damage and/or failure of the arrester. As a result, conventional solid-core arrestors may not be optimally suited for high-voltage applications and/or applications that subject the solid-core arrester to high mechanical forces.

The cantilever strength of a solid-core arrester may be increased by wrapping the active area (the MOVs) of the arrester with a composite material layer such as discussed below. The composite material is made of a fiber reinforced resin matrix material. The material layer is configured to provide sufficient axial strength to allow the arrester to withstand demanding conditions while also allowing the arrester to vent gases and/or plasmas upon failure or malfunction. For example, the arrangement of the fibers included in the material layer provides axial strength to the arrester. Additionally, the arrangement of the fibers allows overlapping layers of the material to be applied to the surface of the MOV disks. For example, the alignment of fibers in the axial direction results in regions of the layered material being resin rich regions that have few or no fibers, that serve as venting regions. The alignment of the fibers and/or the presence of multiple layers result in a solid-core arrester that is suitable for use in distribution class and station class surge arrester applications, applications that require the solid-core arrester to withstand high mechanical forces (e.g., a constant, or nearly constant, load of 500-1000 pounds or greater), applications that require a solid-core arrester longer than about 6-8 feet, and/or applications that subject the solid-core arrester to bending moments of up to approximately 100,000 to 360,000 inch-pounds.

As discussed in more detail below, the material layer may include multiple layers of a material that includes fibers arranged such that, when the material is applied to the MOVs, the majority of the fibers are aligned with the axial direction of the MOVs. Such an arrangement of fibers allows the material to be layered onto the surface of the MOV, thus providing cantilever strength, while also allowing venting of gases and/or plasmas from the arrester. In contrast, applying many layers of existing composite materials that include approximately equal amounts of fibers in multiple directions may result in diminished (or no) venting of gases. For example, overlapping layers of materials that include fibers in multiple directions may result in the fibers of one layer blocking a fiber-free, or relatively fiber-free, region of an underlying layer. Insufficient venting may cause the arrester to explode or rupture, causing expulsion of the MOV and other components within the arrester and leading to destruction of nearby equipment.

In some implementations, a venting region is formed in the material layer such that the solid-core arrester is a directionally venting solid-core arrester that vents gases in a predictable direction. The predictable direction may be one or more preferential directions and/or one or more particular directions. Directional venting allows, for example, vented gases to be constrained to a particular direction(s) or preferential directions(s) such that the vented gases are directed away from adjacent or nearby equipment and/or adjacent phases, thus reducing or eliminating collateral damage resulting from a malfunction or failure of the solid-core arrester. The venting region is a region in the material layer that is modified such that gases created upon failure or malfunction of the surge arrester escape through the venting region.

Use of the material layer in station class and distribution class surge arresters may allow solid-core arresters to be used in place of larger expensive hollow core porcelain or hollow core polymer arresters. Further, solid-core designs are generally less susceptible to moisture ingress related failure due to the lack of a gas space subjected to seal pumping action and less violent gas escape.

In one general aspect, a solid-core surge arrester includes a module assembly. The module assembly includes at least one metal oxide varistor (MOV) disk with an outer circumferential surface. The solid-core surge arrester also includes a material applied to the outer circumferential surface, the material including multiple layers to allow the module assembly to withstand a bending moment under an approximately continuously applied load, and the material being configured to allow venting of gas that forms in the module assembly upon failure of the module assembly.

In another general aspect, a solid-core surge arrester includes a module assembly. The module assembly includes at least one metal oxide varistor (MOV) disk with an outer circumferential surface, and a material applied to the outer circumferential surface. The material includes multiple layers to allow the module assembly to withstand a bending moment under an approximately continuously applied load, and the material is configured to allow venting of gas that forms in the module assembly in a preferential direction.

Implementations may include one or more of the following features. A venting region along an axial direction of the module assembly may allow the venting of gas unidirectionally, and the venting region may be defined by a boundary formed by the material. A venting region along an axial direction of the module assembly may allow the venting of gas directionally in the preferential direction, and the venting region may be defined by a boundary formed by the material. The boundary in the material may have a length that is equal to or greater than the axial length of the MOV disk. Gas may vent radially outward from the boundary and perpendicular to the module assembly. A second material may be applied to an outer surface of the material that is configured to allow venting of gas.

In some implementations, the material includes fibers aligned in more than one direction, with a majority of the fibers being oriented in a first direction, and the material is applied to the MOV disk such that the majority of the fibers are aligned along an axial direction of the MOV disk. More than 90% of the fibers of the material may be oriented in the first direction. The material may include a minority of fibers oriented in a second direction, and the material may define a first boundary by severing at least one of the fibers oriented in the second direction. The material may define a second boundary, and the first boundary and the second boundary may be separated along the outer circumferential surface.

In some implementations, the material includes more than one portion and the portions are applied to the outer circumferential surface of the MOV disk such that the material defines a boundary between any two of the portions. One portion may cover an area substantially smaller than the coverage area of another portion. A second material may be applied to the more than one portions such that the portions are between the MOV disk and the second material.

In some implementations of the solid-core surge arrester, the gas vents in random radial directions through venting regions formed within the matrix included in the reinforced composite material. The material that includes multiple layers may allow the module assembly to withstand a bending moment greater than 40,000 in-lbs. The material that includes multiple layers may allow the module assembly to withstand a bending moment greater than 20,000 in-lbs.

In another general aspect, a solid-core surge arrester includes a module assembly that includes at least one metal oxide varistor (MOV) disk with an outer circumferential surface, and a material layer of non-uniform thickness applied to the outer circumferential surface, the material layer including a vent configured to allow venting of gas that forms in the module assembly upon failure.

Implementations may include one or more of the following features. The material layer may include a first material applied to the outer circumferential surface of the at least one MOV, and a second material applied to the first material, the second material being wrapped to surround the first material such that a first segment of the material layer includes multiple layers of the second material and a second segment of the material layer includes fewer layers of the second material. The first segment of the material layer includes at least one layer and the second segment of the material layer includes at least two layers. At least three layers of the first material may be applied to the outer circumferential surface.

In another general aspect, a method of assembling a solid-core surge arrester includes applying a material to a circumferential surface of a metal oxide varistor (MOV) disk, the material configured to allow surge arrester to withstand a bending moment under an approximately continuously applied load, and, forming, with the material, a material layer around the MOV disk.

Implementations may include one or more of the following features. Forming the material layer may include applying more than three layers of the material to the circumferential surface of the MOV disk, and wrapping a second material around the more than three layers of the material. Forming the material layer may include applying multiple portions of the material to the circumferential surface of the MOV, the portions being positioned such that boundary is formed between any two of the portions, and each of the portions may include at least three layers of the material. Forming the material layer may include forming a layer of non-uniform thickness over the material, the layer of non-uniform thickness including a relatively thinner portion.

Implementations of any of the techniques described above may include an arrester, a process, a system, a device, an apparatus, a material layer, or a solid-core directionally venting surge arrester. The details of one or more implementations are set forth in the accompanying drawings and the description below. Other features will be apparent from the description and drawings, and from the claims.

### DESCRIPTION OF THE DRAWINGS

FIG. 1 shows a vertical cross-section of a solid-core surge arrester including a material layer.

FIGS. 2-7 and 9 show cross-sectional views of a metal oxide varistor (MOV) disk with a material layer applied to an outer circumferential surface of the MOV disk.

FIG. 8 shows a system that includes a directionally venting solid-core arrester including a material layer.

FIG. 10 shows a vertical cross-section of another solid-core surge arrester.

FIG. 11 shows a process for making a solid-core surge arrester.

Like reference symbols in the various drawings may indicate like elements.

### DETAILED DESCRIPTION

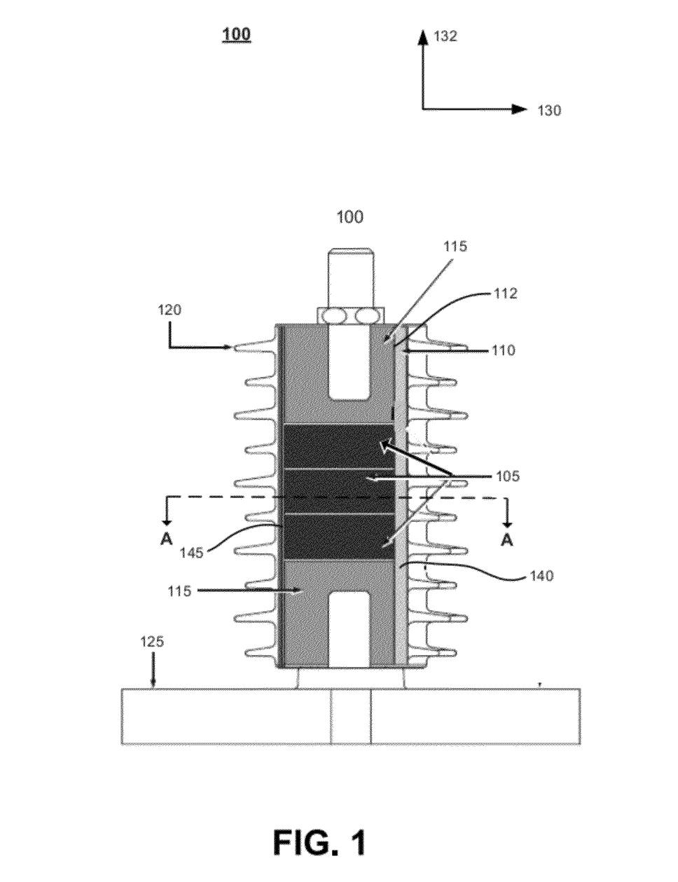

Referring to FIG. 1, a vertical cross-section of an exemplary surge arrester 100 is shown. The surge arrester 100 includes one or more metal oxide varistor (MOV) disks 105, a material layer 110, electrodes 115, and a housing 120. The housing 120 may be a silicon rubber housing, and the housing 120 may be a weather shed material that is designed to allow the surge arrester 100 to be used outside even when exposed to challenging environmental conditions, such as rain, ice, and snow.

The material layer 110 is applied to an outer circumferential surface 112 of the MOV disks 105, and, in some implementations, to the surface of the electrodes 115. The surge arrester 100 is mounted on a mounting base 125. The material layer 110 has a non-uniform thickness such that the material layer 110 is thicker, in a radial direction 130, on one side of the surge arrester 100. The thicker portion is shown on the right side of the arrester 100. The non-uniform thickness of the material layer 110 results in a relatively thicker covering on the MOV disks 105 at a region 140, and a relatively thinner covering of the MOV disks 105 at a region 145.

As discussed in greater detail below, the relatively thinner portion of the material layer 110 forms a vent at the region 145 that allows the venting of gases and/or plasmas that may form upon failure or malfunction of the arrester 100. The presence of the vent allows multiple layers of a material to be applied to the surface of the MOV disks 105. Applying multiple layers (for example, three or more layers) of the material provides strength to the arrester 100 such that the arrester 100 is suitable for use in high-voltage applications and/or applications requiring high axial strength.

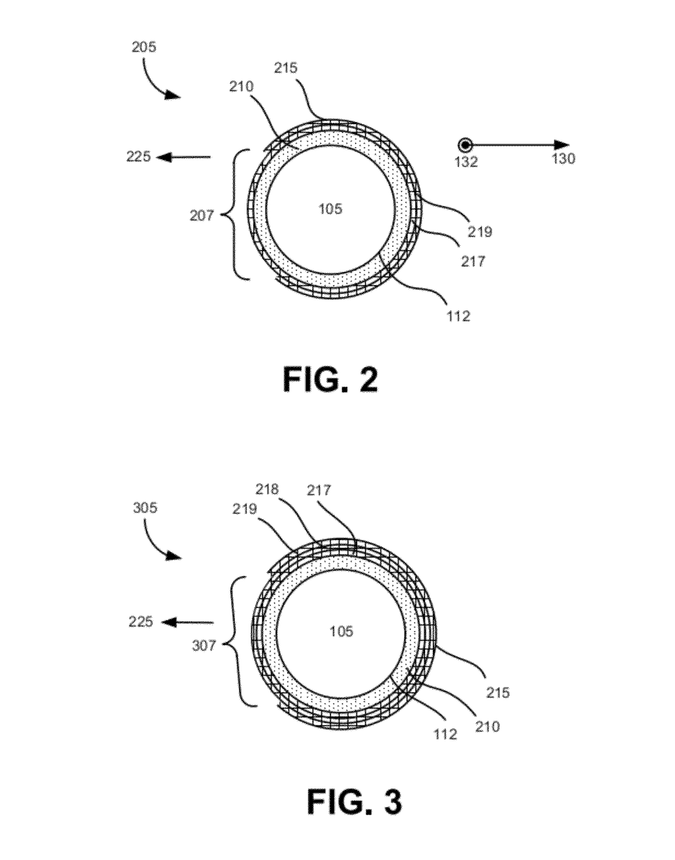

FIG. 2 shows a cross-sectional view of the MOV disk 105 along the line “A” shown in FIG. 1. In the example shown in FIG. 2, a material layer 205 is applied to the outer circumferential surface 112 of the MOV disk 105. The material layer 205 has a non-uniform thickness in the radial direction 130 such that a relatively thinner portion 207 is formed. The relatively thinner portion 207 prevents or minimizes the occurrence of catastrophic failure of the arrester 100 by allowing gases and/or plasma to vent radially outward from the arrester 100 through the relatively thinner portion 207. The relatively thinner portion 207 may be referred to as a vent.

The material layer 205 includes a first material 210 that is applied to the outer circumferential surface 112 of the MOV disk 105, and a second material 215 that is applied to the first material 210. In the example shown in FIG. 2, the second material 215 is wrapped around the first material 210 once with a first layer 217 and then again with second layer 219. The second layer 219 covers a portion of the first layer 217. For example, the second layer 219 may cover 80%-90% of the first layer 217. The remaining portion of the outer circumferential surface 112 is covered with the first material 210 and the first layer 217 of the second material 215, and this remaining portion is the thinner portion 207. Thus, in the example shown in FIG. 2, the first layer 217 of the second material 215 is present in the thinner portion 207, and the first layer 217 and the second layer 219 are present around the other portion of the MOV disk 105.

The first material 210 and the second material 215 include fibers between which voids are formed. The voids are essentially filled with epoxy or another material that physically breaks down upon exposure to heat (such as during arrester malfunction or failure). Breakdown of the epoxy in the voids provides regions and/or points of pressure relief for the gases and/or plasma that may be produced by when the arrester 100 fails.

The fibers of the first material 210 may be aligned in more than one direction relative to the outer circumferential surface 112 of the MOV disk 105; however, the fibers of the first material 210 are preferentially aligned in a particular direction. For example, the first material 210 may be a material that includes fibers in two directions, with the majority of fibers of the first material 210 being aligned in the axial direction 132, or nearly aligned in the axial direction 132, once the first material 210 is applied to the circumferential surface 112. The minority of fibers may be aligned in the radial direction 130. In some implementations, more than 90% of the fibers in the first material 210 are aligned in the axial direction 132. For example, 99% of the fibers in the first material 210 may be aligned in the axial direction 132. The first material 210 may be referred to as a uni-directional material, and, in some implementations, the first material 210 includes fibers aligned in a single direction. Alignment of the majority of the fibers in the radial direction 130 allows multiple layers of the first material 210 to be applied to the surface 112 of the MOV desk 105, and the presence of multiple layers and the axially aligned fibers provides cantilever strength to the arrester 100. Additionally, because the majority of fibers are arranged in the axial direction 132, the fibers in various overlapping layers of the first material 210 tend not to block or obscure the voids in the inner layers of the first material 210.

As a result of the orientation of the fibers in the first material 210, multiple layers, for example more than three layers, of the first material 210 may be applied to the circumferential surface 112. The presence of the multiple layers of the first material 210 and the alignment of the fibers of the first material 210 in the axial direction 132 lend cantilever and/or axial strength to the arrester 100, while also allowing the arrester 100 to vent gases and/or plasma upon failure.

The second material 215 includes fibers that are aligned in more than one direction. The second material 215 may be a material that includes an approximately equal portion of fibers in each of the directions. For example, the second material may be a bi-directional material that includes approximately half of the fibers in the axial direction 132, with the remaining fibers aligned in the radial direction 130.

The fibers of the first material 210 and the second material 215 may be made from an inorganic, insulating material capable of being shaped into fibers. For example, the fibers may be glass fibers, alumina fibers, or carbon fibers. To create the first material and the second material 215, the fibers may be bundled and oriented into a matrix that has bundles of fibers at regular, or nearly regular, spatial intervals or in a fabric. The matrix includes voids between the bundles. For implementations that employ a fabric, the fabric may be stitched to create regularly, or nearly regularly, spaced voids in the fabric, and these voids are filled with a material (such as epoxy) that breaks down in the presence of heat.

Gases and/or plasma that exit through the portion 207 exit the arrester 100 in a direction that is determined by the orientation of the portion 207 relative to the surge arrester 100. Thus, application of the material layer 205 to the MOV disks 105 results in a solid-core surge arrester that can vent gases and/or plasmas in a predictable direction.

FIG. 3 shows a cross-sectional view of the MOV disk 105 with another example material layer 305 that is applied to the outer circumferential surface 112. The view shown in FIG. 3 is taken along line “A” of FIG. 1. The material layer 305 includes the first material 210, which is applied to the outer circumferential surface 112 of the MOV disk 105, and the second material 215, which is applied to the first material 210. As discussed above, because of the orientation of the fibers in the first material 210, the material layer 305 may include multiple layers (not shown) of the first material 210.

In the example of FIG. 3, a first layer 217 and a second layer 218 of the second material 215 is wrapped around the first material 210, and a third layer 219 is wrapped partially around the second layer 218. For example, the third layer 219 may cover 80%-90% of the second layer 218. Thus, a relatively thinner portion 307 of the material layer 305 is formed at the portion of the second layer 218 that is not covered by the third layer 219.

In the examples discussed above, the second material 215 is wrapped around the first material 210 such that the relatively thinner portion 207 or 307 includes one less layer than the other portion of the material layer 205 or 305. However, in other examples, the second material 215 may be applied to the first material 210 other than by wrapping, for example, the section material may be applied in strips. In these implementations, the relatively thinner portion of the material layer may include more than one fewer layer than the other portion of the material layer.

Gases and/or plasma that exit through the portion 307 exit the arrester 100 in a direction that is determined by the orientation of the portion 307 relative to the surge arrester 100. For example, the portion 307 may be elongated in the axial direction 132 such that gases and/or plasmas exit radially outward from the arrester 100 in a direction 225.

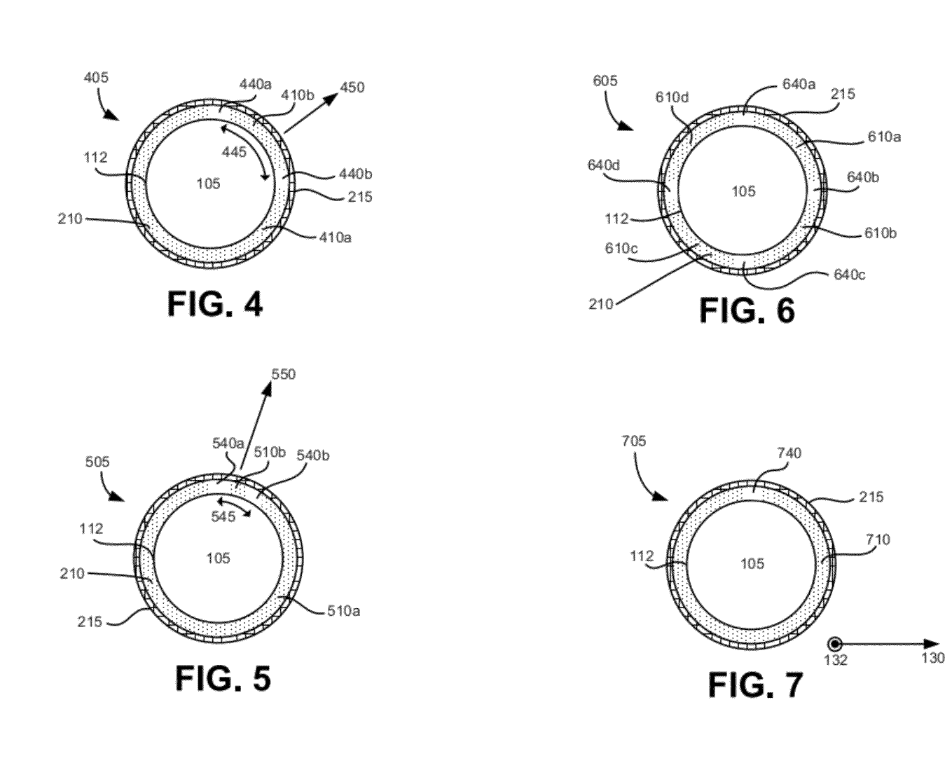

FIGS. 4-7 show cross-sectional views of the MOV disks 105 with other example material layers applied to the outer circumferential surface 112 of the MOV disks 105. When employed in a solid-core surge arrester such as the arrester 100, the material layers shown in FIGS. 4-7 result in a directionally vented solid-core arrester that vents gases and/or plasmas radially outward from the arrester 100 in a direction determined by the configuration of the material layer. In the examples shown in FIGS. 4-7, the material layers include multiple and discrete portions of the first material 210 that are applied to the outer circumferential surface 112 in layers, and the applied portions of the first material 210 are separated by gaps formed by the portions. The gaps formed by the portions of the first material 210 are covered by the second material 215. The circumferential positioning of the gaps relative to the surface 112 of the MOV disk 105 determines the direction in which the gases and/or plasmas are vented.

Referring to FIG. 4, a material layer 405 includes two portions 410a and 410b of the first material 210, which are applied to the outer circumferential surface 112 of the MOV disk 105. Gaps 440a and 440b are between the portions 410a and 410b. The portion 410a covers the majority of the circumferential surface 112. The portion 410b, which is circumferentially between the ends of the portion 410b and the gaps 440a and 440b, forms a vent 445 through which gases and/or plasma exit along a direction 450 from the arrester 100. Thus, the circumferential distance between the gap 440a and the gap 440b determines the size of the vent 445.

In some implementations, the portion 410a is 7-inches wide and covers 7-inches of the circumferential surface 112, and the portion 410b is 2⅜-inches wide. Thus, the portion 410b covers approximately 25% of the outer circumferential surface 112. The portions 410a and 410b may be sized to fit a particular MOV disk while maintaining the ratio between the size of the portion 410a and 410b. In other implementations, the circumferential separation between the gap 440a and the gap 440b along the surface 112 may be, for example, 30° or 60° or a circumferential separation between these two values.

As discussed with respect to FIG. 2, the first material 210 includes fibers, the majority of which are aligned in the axial direction 132, and the first material 210 may be layered on the MOV disk 105 to provide cantilever strength to the arrester 100. For example, each of the portions 410a and 410b may include six layers (not shown) of the first material.

The gaps 440a and 440b may be formed by severing, cutting, or otherwise weakening the hoop direction (circumferential direction) fibers in the first material 210. Some or all of the hoop direction fibers in the vicinity of a region through which venting of gases is desired may be severed to create a gap. For example, in some implementations, 85% of the hoop fibers may be severed. In some implementations the gap may extend in the axial direction for the entire length of the MOV disks 105.

In other implementations, the portions 410a and 410b may be pre-cut strips of the material 210, and the gaps 440a and 440b are be formed by placing the pre-cut strips onto the outer circumferential surface 112 such that edges of the strips do not touch each other. In these implementations, the portions 410a and 410b each may be preformed layered portions that are then applied to the outer circumferential surface 112, or the portions 410a and 410b may be built up layer by layer on the surface 112.

In the example shown in FIG. 4, a layer of the second material 215 is applied over the portions 410a and 410b. More than one layer of the second material 215 may be applied over the portions 410a and 410b. For example, three layers of the second material 215 may be applied over the portions 410a and 410b.

Referring to FIG. 5, a material layer 505 includes two portions 510a and 510b of the first material 210, which are applied to the outer circumferential surface 112 of the MOV disk 105. Gaps 540a and 540b are between the portions 510a and 510b. The portion 510a covers the majority of the circumferential surface 112. In some implementations, the portion 510a is 8-inches wide and covers 8-inches of the circumferential surface 112, and the portion 510b is 1.5-inches wide. The portion 510b, which is circumferentially between the ends of the portion 510a and the gaps 540a and 540b, forms a vent 545 through which gases and/or plasma exit along a direction 550 from the arrester 100. The portions 510a and 510b may include multiple layers of the first material 210. For example, each of the portions 510a and 510b may include three to six layers of the first material 210. In some implementations, each of the portions 510a and 510b include a different number of layers of the first material 210.

The gaps 540a and 540b may be formed by applying the portions 510a and 510b to the outer circumferential surface 112 such that a boundary, defined by the edges of the portions 510a and 510b, is formed. In other implementations, the gaps 540a and 540b may be formed by applying the first material 210 to the surface 112 of the MOV disk 105 and then severing the hoop direction fibers in the first material 210 to create the gaps 540a and 540b.

The portions 510a and 510b of the first material 210 are covered by a layer of the second material 215. In some implementations, more than one layer of the second material 215 is applied, for example, three or fewer layers of the second material 215 may be applied.

Referring to FIG. 6, an example material layer 605 includes four portions 610a, 610b, 610c, and 610d of the first material 210, which are applied to the outer circumferential surface of the MOV disk 105. Gaps 640a, 640b, 640c, and 640d are formed between the portions. One or more layers of the second material 215 are applied to the four portions 610a, 610b, 610c, and 610d. In some implementations, one or more of the portions 610a, 610b, 610c, and 610d may include multiple overlapping layers of the first material 210. However, any or all of the portions 610a-610d may be made from a single layer of the first material 210. Referring to FIG. 7, another example material layer 705 includes a single portion 710 that is applied to the outer circumferential surface 112. A gap 740 is formed between the edges of the applied portion 710. The portion 710 may include multiple overlapping layers of the first material 210 or the portion 710 may include a single layer of the first material 210. The material layers 605 and 705 also include one or more layers of the second material 215.

The example material layers shown in FIGS. 4-7 include one or more outer layers of the second material 215. However, this is not necessarily the case. In some implementations, the material layer may include only the inner layers of the first material 210.

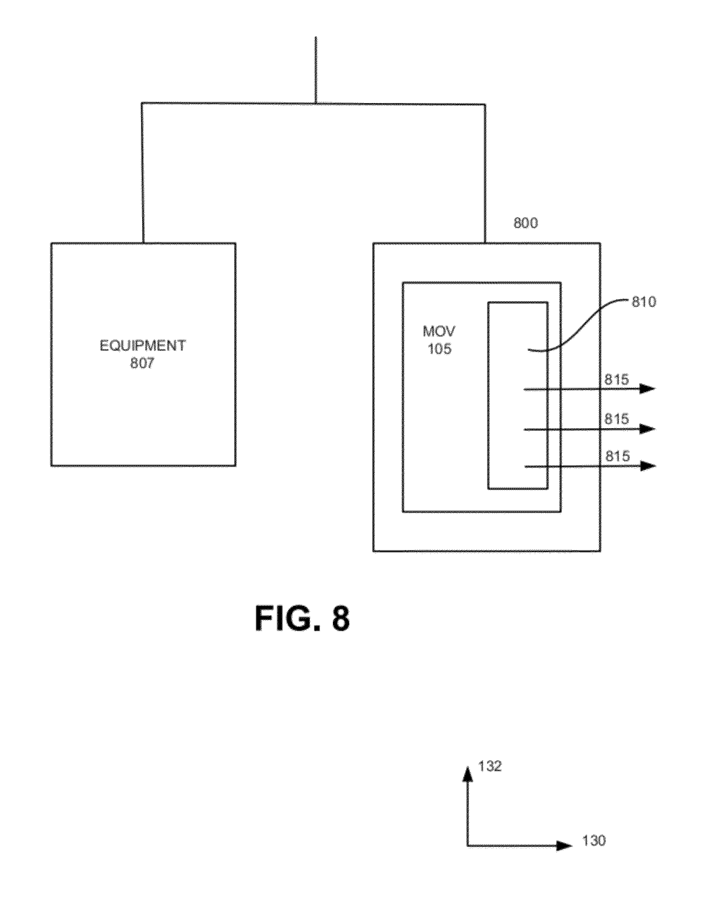

Referring to FIG. 8, a perspective view of an example directionally venting solid-core surge arrester 800 is shown. The surge arrester 800 includes the MOV disk 105, and the surge arrester 800 is connected in parallel with equipment 807 to protect the equipment 807 from over-voltage conditions. The surge arrester 800 includes a material layer (not shown) that forms a vent 810 through which gases and/or plasmas, which may be formed during arrester failure, exit. The axial length of the vent 810 in the direction 132 may be, for example, the same as the axial length of the surge arrester 800, the axial length of the MOV disk 105, less than the axial length of the MOV disk 105, or some other axial length. The circumferential width of the vent 810 in the direction 130 is determined by the size of the opening formed in an inner layer of material (such as the gaps discussed with respect to FIGS. 4-7) or by the presence of a portion of a material layer that is relatively thinner than other portions of the material layer (such as the relatively thinner portions 207 and 307 shown, respectively, in FIGS. 2 and 3).

The solid-core surge arrester 800 directionally vents gases and/or plasmas in the direction 815, and the position and/or orientation of the vent 810 relative to the surge arrester 800 determines the direction 815. The gases and/or plasmas vent outward from the surge arrester in the direction 815. In the example of FIG. 8, the presence of the vent 810 allows the gases and/or plasmas to be vented away from the protected equipment 807 such that the damage to the equipment 807 from the gases and/or plasmas is reduced or eliminated. Additionally, venting the gases from the surge arrester 800 minimizes the probability of components internal to the surge arrester being expelled.

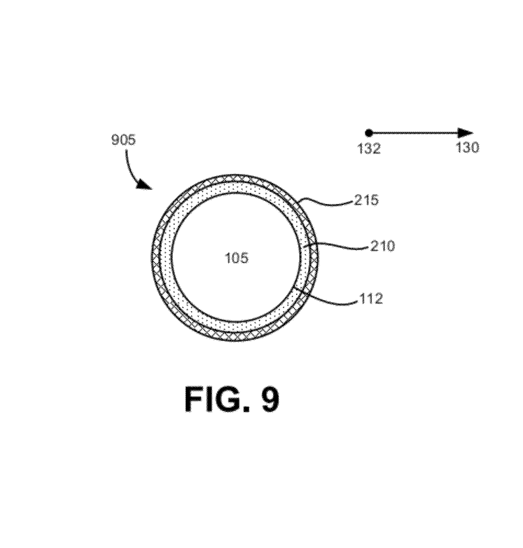

FIG. 9 shows a cross-sectional view of the MOV disks 105 with another example material layer 905 applied to the outer circumferential surface 112. The material layer 905 includes one or more layers of the first material 210, which are applied to the outer circumferential surface 112, and one or more layers of the second material 215, which are applied to the first material 210. The first material 210 includes fibers, the majority of which are aligned in the axial direction 132, and the first material 210 is employed to provide axial strength to the MOV disk 105. The first material 210 may include multiple overlapping layers. The material layer 905 also includes one or more layers of the second material 215 applied over the first material 210. For example, the material layer 905 may include three or fewer layers of the second material 215.

In contrast to the examples discussed in FIGS. 1-8, the material layer 905 does not include a vent or a relatively thinner portion. As a result, gases and/or plasmas that form in an arrester that includes the material layer 905 vent in random directions outward from the arrester. The material layer 905 may be considered to allow random radial venting of gases and/or plasmas. The ability to vent the gases and/or plasmas allows the arrester to fail or malfunction in a safe fashion by reducing or eliminating the forcible expulsion of components of the arrester (such as MOV disks) from the arrester. Additionally, the inner layer of the first material 210 provides the arrester with axial strength such that an arrester employing the material layer 905 may be used in high-voltage and/or high-strength applications.

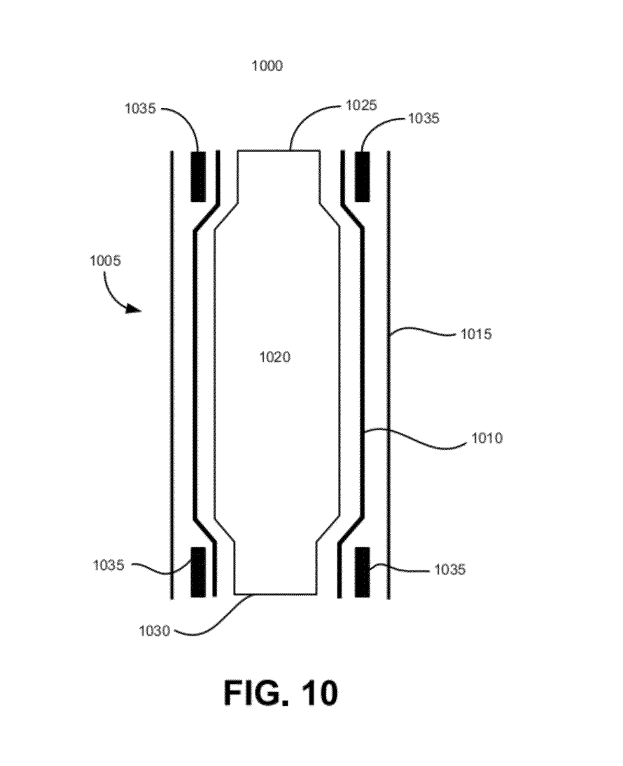

FIG. 10 shows a vertical cross-section of another example surge arrester 1000. The surge arrester 1000 includes a material layer 1005 that may be similar to the material layers discussed above. The material layer 1005 includes an inner layer 1010 made of one or more layers of the first material 210 and an outer layer 1015 that includes one or more layers of the second material 215. The surge arrester also includes a module 1020 that includes electrodes (not shown) on ends 1025, 1030 of the module 1020 and at least one MOV disk (not shown) between the electrodes. The inner layer 1010 is applied to the module 1020. Bands 1035 are wrapped around the module 1020 where the inner layer 1010 meets the electrodes that are located at the ends 1025, 1030 of the module 1020. In some implementations, the bands 1035 may be continuous fibers that are approximately 0.75-inches wide in the axial direction and 27-inches long in the circumferential direction. The outer layer 1015 is applied to the inner layer 1010 and to the bands 1035. The bands 1035 may reduce or eliminate venting from the ends 1025, 1030. Although the example shown in FIG. 10 includes the bands 1035, the surge arrester 1000 may be constructed without the bands 1035.

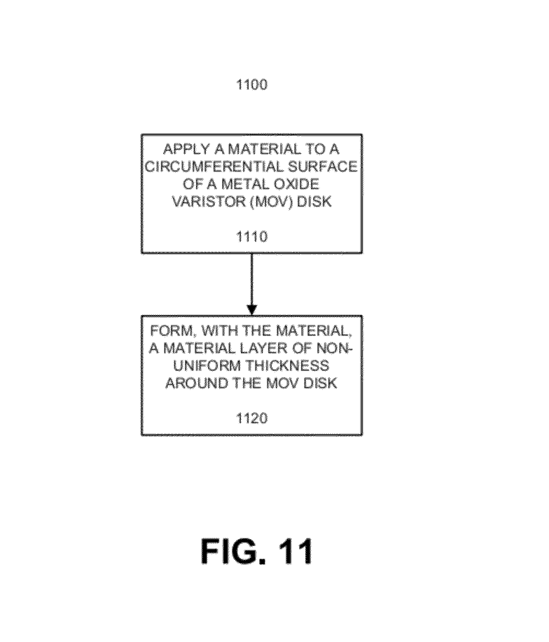

FIG. 11 shows an example process for making a solid-core surge arrester. The process 1100 may be used to form a solid-core surge arrester that allows gases and/or plasmas to vent through a material layer to allow or facilitate the safe failure of the arrester and also to provide sufficient axial strength to the arrester such that the arrester is useable in high-voltage applications. The process 1100 may be used to make a solid-core surge arrester that is directionally venting or an arrester that vents in random directions.

A material 210 is applied (1110) to a circumferential surface 112 of a metal oxide varistor (MOV) disk 105. The material 210 is configured to allow the surge arrester that includes the MOV disk 105 to withstand a bending moment under an approximately constantly applied force. The force may be, for example, an approximately constant force of at least 500 pounds. The bending moment depends on the length of the surge arrester and may be, for example, greater than 20,000 inch-pounds, greater than 40,000 in-pounds, or greater than 100,000 inch-pounds. The material 210 may be a material that includes fibers oriented in more than one direction, with a majority of the fibers oriented in one direction. The material 210 may be applied to the surface 112 such that the majority of fibers in the material 210 are aligned along an axial direction of the MOV disk 105.

A material layer is formed around the MOV disk with the material (1120). Forming the material layer may include applying more than three layers of the material 210 to the outer circumferential surface 112 of the MOV disk 105 and wrapping the second material 215 around the more than three layers of the material 210. In these implementations, the material layer may be similar to the material layer 905, which allows random radial venting and is shown in FIG. 9. In some implementations, forming the material layer may include applying multiple portions of the material 210 to the outer circumferential surface 112. Each of the multiple portions of the material 210 may include multiple layers of the material 210. In some implementations, forming the material layer includes forming a layer of non-uniform thickness over the first material 210. The layer of non-uniform thickness includes a relatively thinner portion (such as the relatively thinner portions 207 and 307 shown in FIGS. 2 and 3, respectively) that facilitates venting of gases and/or plasmas that may be formed by the failure or malfunction of the arrester.

The application of the material layer to the outer circumferential surface 112 of the MOV disk 105 may include a number of techniques. For example, application of the material layer to the surface 112 may include wet wrap techniques, prepreg techniques, and/or resin infusion.

Other implementations are within the scope of the claims.

What is claimed is:

1. A solid-core surge arrester comprising:
a module assembly comprising at least one metal oxide varistor (MOV) disk with an outer circumferential surface; and
a material applied to the outer circumferential surface, the material comprising multiple layers to allow the module assembly to withstand a bending moment under an approximately continuously applied load, and the material being configured to allow-venting of gas that forms in the module assembly in a preferential direction.

2. The surge arrester of claim 1, wherein a venting region along an axial direction of the module assembly allows the venting of gas directionally in the preferential direction, and the venting region is defined by a boundary formed by the material.

3. The surge arrester of claim 2, wherein the boundary in the material has a length that is equal to or greater than the axial length of the MOV disk.

4. The surge arrester of claim 2, wherein the gas vents radially outward from the boundary and perpendicular to the module assembly.

5. The surge arrester of claim 2, further comprising a second material applied to an outer surface of the material.

6. The surge arrester of claim 1, wherein the material comprises fibers aligned in more than one direction, with a majority of the fibers being oriented in a first direction, and the material is applied to the MOV disk such that the majority of the fibers are aligned along an axial direction of the MOV disk.

7. The surge arrester of claim 6, wherein more than 90% of the fibers of the material are oriented in the first direction.

8. The surge arrester of claim 6, wherein the material comprises a minority of fibers oriented in a second direction, and the material defines a first boundary by severing at least one of the fibers oriented in the second direction.

9. The surge arrester of claim 8, wherein the material defines a second boundary, the first boundary and the second boundary being separated along the outer circumferential surface.

10. The surge arrester of claim 1, wherein the material comprises more than one portion and the portions are applied to the outer circumferential surface of the MOV disk such that the material defines a boundary between any two of the portions.

11. The surge arrester of claim 10, wherein one portion covers an area substantially smaller than the coverage area of another portion.

12. The surge arrester of claim 10, further comprising a second material applied to the more than one portions such that the portions are between the MOV disk and the second material.

13. The surge arrester of claim 1, wherein the gas vents in random radial directions through venting regions formed by fibers included in the material.

14. The surge arrester of claim 1, wherein the material comprising multiple layers allows the module assembly to withstand a bending moment greater than 40,000 in-lbs.

15. The surge arrester of claim 1, wherein the material comprising multiple layers allows the module assembly to withstand a bending moment greater than 20,000 in-lbs.

16. A solid-core surge arrester comprising:
a module assembly comprising at least one metal oxide varistor (MOV) disk with an outer circumferential surface; and
a material layer of non-uniform thickness applied to the outer circumferential surface, the material layer comprising a vent configured to allow venting of gas that forms in the module assembly upon failure.

17. The surge arrester of claim 16, wherein the material layer comprises:
a first material applied to the outer circumferential surface of the at least one MOV; and
a second material applied to the first material, the second material being wrapped to surround the first material such that a first segment of the material layer comprises multiple layers of the second material and a second segment of the material layer comprises fewer layers of the second material.

18. The surge arrester of claim 17, wherein the first segment of the material layer comprises at least one layer and the second segment of the material layer comprises at least two layers.

19. The surge arrester of claim 17, wherein at least three layers of the first material are applied to the outer circumferential surface.

20. A method of assembling a solid-core surge arrester, the method comprising:
applying a material to a circumferential surface of a metal oxide varistor (MOV) disk, the material configured to allow surge arrester to withstand a bending moment under an approximately continuously applied load; and
forming, with the material, a material layer around the MOV disk.

21. The method of claim 20, wherein forming the material layer comprises applying more than three layers of the material to the circumferential surface of the MOV disk, and wrapping a second material around the more than three layers of the material.

22. The method of claim 20, wherein forming the material layer comprises applying multiple portions of the material to the circumferential surface of the MOV, the portions being positioned such that a boundary is formed between any two of the portions, and each of the portions comprises at least three layers of the material.

23. The method of claim 20, wherein forming the material layer comprises forming a layer of non-uniform thickness over the material, the layer of non-uniform thickness comprising a relatively thinner portion.

24. The method of claim 20, wherein the material allows the surge arrester to withstand a bending moment greater than 40,000 in-lbs.

25. The method of claim 20, wherein the material allows the surge arrester to withstand a bending moment greater than 20,000 in-lbs.
